(19) United States
(12) Patent Application Publication
(10) Pub. No.: US 2003/0184078 A1
(43) Pub. Date: Oct. 2, 2003

(54) Mud flap lifting system

(76) Inventor: Ronald W. Grable, Mogadore, OH (US)

Correspondence Address: Fred H. Zollinger, III, SAND & SEBOLT, Aegis Tower, 4940 Munson Street, NW, Suite 1100, Canton, OH, 44718-3615, US

(21) Appl. No.: 10/390,299

(22) Filed: Mar. 17, 2003

Related U.S. Application Data
(60) Provisional application No. 60/369,465, filed on Apr. 1, 2002.

(51) Int. Cl. B62B 9/14

(52) U.S. Cl. 280/847

(57) ABSTRACT

A mud flap lifting system is powered by the pneumatic system that is already present on the dump truck. The system uses a pneumatic actuator to drive a rod between first and second positions. Mud flap assemblies are connected to the rod and are disposed at an extended position when the rod is at the first position. The assemblies are disposed in a retracted position when the rod is in the second position. Each mud flap assembly includes an upper portion and a lower portion that are connected together with a hinge. The upper portion of the assembly is designed to be tilted upwardly in toward the tire when the assembly is moved to the retracted position from the extended position. When the upper portion moves up and in, the lower portion moves up and in while remaining substantially vertical. This position keeps the flaps out of the way when the truck dumps its load to prevent the flaps from being damaged.

### CROSS REFERENCE TO RELATED APPLICATIONS

This application claim priority from U.S. provisional application serial No. 60/369,465 filed Apr. 1, 2002; the disclosures of which are incorporated herein by reference.

### BACKGROUND OF THE INVENTION

1. Technical Field

The present invention generally relates to mud flap lifting systems for dump trucks. More particularly, the invention relates to a mud flap lifting system disposed below the bed of the truck that is capable of lifting the mud flaps between extended and retracted positions.

2. Background Information

Mud flaps on dump trucks stop a large portion of dirt and mud from being thrown up into the air when the vehicle is in motion. Mud flaps protect the vehicles between the truck and most states require mud flaps to be used on certain classes of trucks. Most states also legislate the size and position of the mud flaps with respect to the wheels. These requirements usually place the lower edge of each mud flap somewhat close to the road surface. Although this position helps stop mud from being thrown off the truck tires, the position also leads to the flaps being torn off the vehicle when the truck dumps its load. This problem has led to a variety of solutions wherein the mud flaps are lifted out of the way when the truck is dumping its load.

Exemplary prior art mud flap lifting or retraction devices are shown in U.S. Pat. Nos. 2,857,200; 2,981,553; 3,248,126; 3,507,513; 3,582,109; 4,097,090; 5,582,431; 6,139,062; and 6,158,775. Despite the various systems disclosed in these patents for moving mud flaps, room for improvement remains in the art.

### BRIEF SUMMARY OF THE INVENTION

The invention provides a mud flap lifting system that is powered by the pneumatic system that is already present on the dump truck. The system uses a pneumatic actuator to drive a rod between first and second positions. Mud flap assemblies are connected to the rod and are disposed at an extended position when the rod is at the first position. The assemblies are disposed in a retracted position when the rod is in the second position. Each mud flap assembly includes an upper portion and a lower portion that are connected together with a hinge. The upper portion of the assembly is designed to be tilted upwardly in toward the tire when the assembly is moved to the retracted position from the extended position. When the upper portion moves up and in, the lower portion moves up and in while remaining substantially vertical. This position keeps the flaps out of the way when the truck dumps its load to prevent the flaps from being damaged.

### BRIEF DESCRIPTION OF THE SEVERAL VIEWS OF THE DRAWINGS

FIG. 1 is a side elevation view of a dump truck using the mud flap lifting system of the present invention.

FIG. 2 is a rear elevation view of the dump truck with portions broken away to show the mud flap lifting system of the present invention.

FIG. 3 is a schematic view of the system elements.

FIG. 4 is a section view of the rear end of the truck showing the mud flap assembly in the extended position.

FIG. 5 is a view similar to FIG. 4 showing the mud flap assembly in the retracted position.

FIG. 6 is a view similar to FIGS. 4 and 5 showing the mud flap assembly in the retracted position with the dump trailer dumping its load.

Similar numbers refer to similar parts throughout the specification.

### DETAILED DESCRIPTION OF THE INVENTION

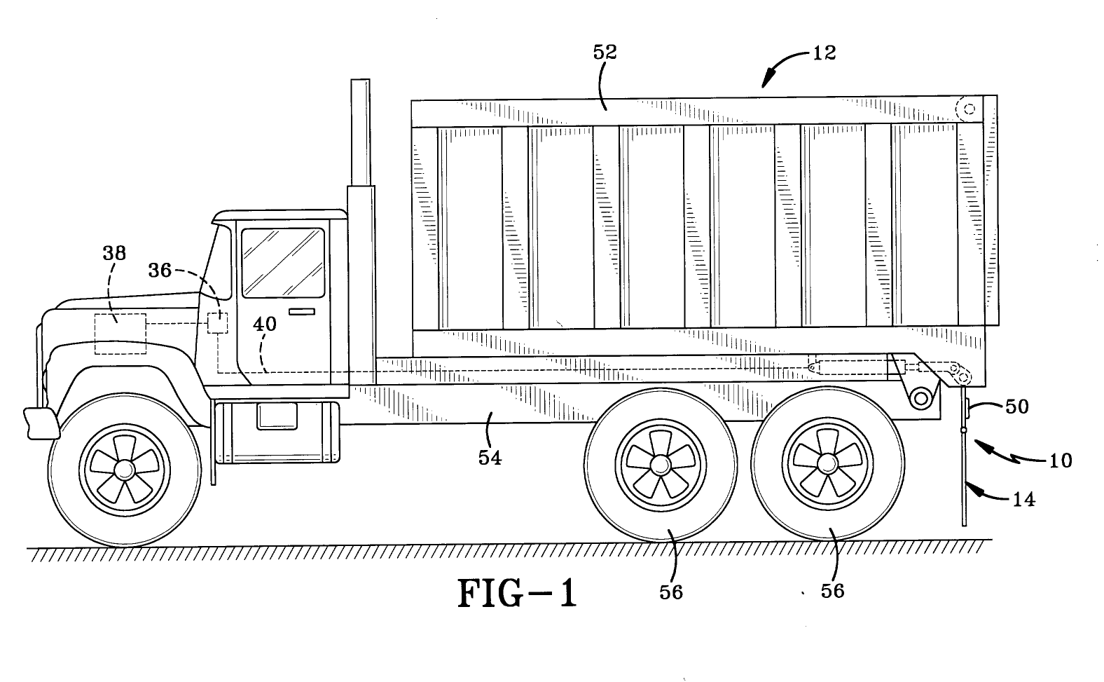

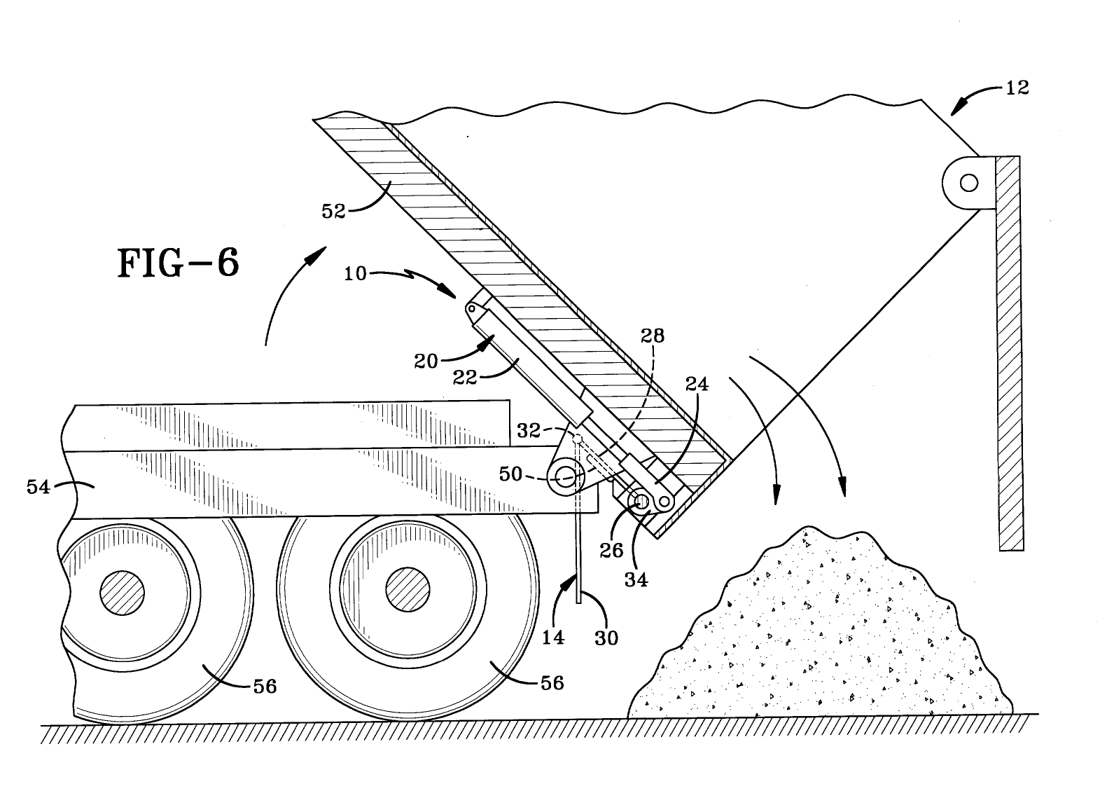

The mud flap lifting system of the present invention is indicated generally by the numeral 10 in the accompanying drawings. Mud flap lifting system 10 is designed to be used with a vehicle 12 such as the dump truck depicted in the drawings. System 10 is particularly useful with dump trucks because mud flaps are easily damaged when dump trucks are dumping loads from their dump beds. System 10 may, however, be used with other types of vehicles. Mud flap lifting system 10 allows mud flap assemblies 14 to be moved from the extended position depicted in FIG. 1 to a retracted position depicted in FIG. 6 so that assemblies 14 are not damaged during the dumping process.

System 10 is schematically depicted in FIG. 3 and generally includes an actuator 20 having a cylinder 22 and a push rod 24. System 10 further includes a bar 26 that is attached to a pair of mud flap assemblies 14. Each mud flap assembly 14 includes a rigid upper portion 28 rigidly attached to bar 26 and a lower portion 30 attached to upper portion 28. In the embodiment of the invention depicted in the drawings, lower portion 30 is connected to upper portion 28 by a hinge 32 that may be a piano-type hinge or any of a variety of other hinges known in the art. Push rod 24 is connected to rod 26 with a lever 34 that is configured to cause rod 26 to pivot upon the extension and retraction of push rod 24. System 10 further includes a valve 36 and a source of pressurized air 38. Air source 38 is connected to valve 36 and actuator 20 with appropriate connectors 40 such as air lines. In other embodiments of the invention, a hydraulic actuator or electric actuator may be used but it has been found that pneumatic actuator 20 is useful because it may be powered by the existing supply of pressurized air found on many vehicles 12 having dump beds.

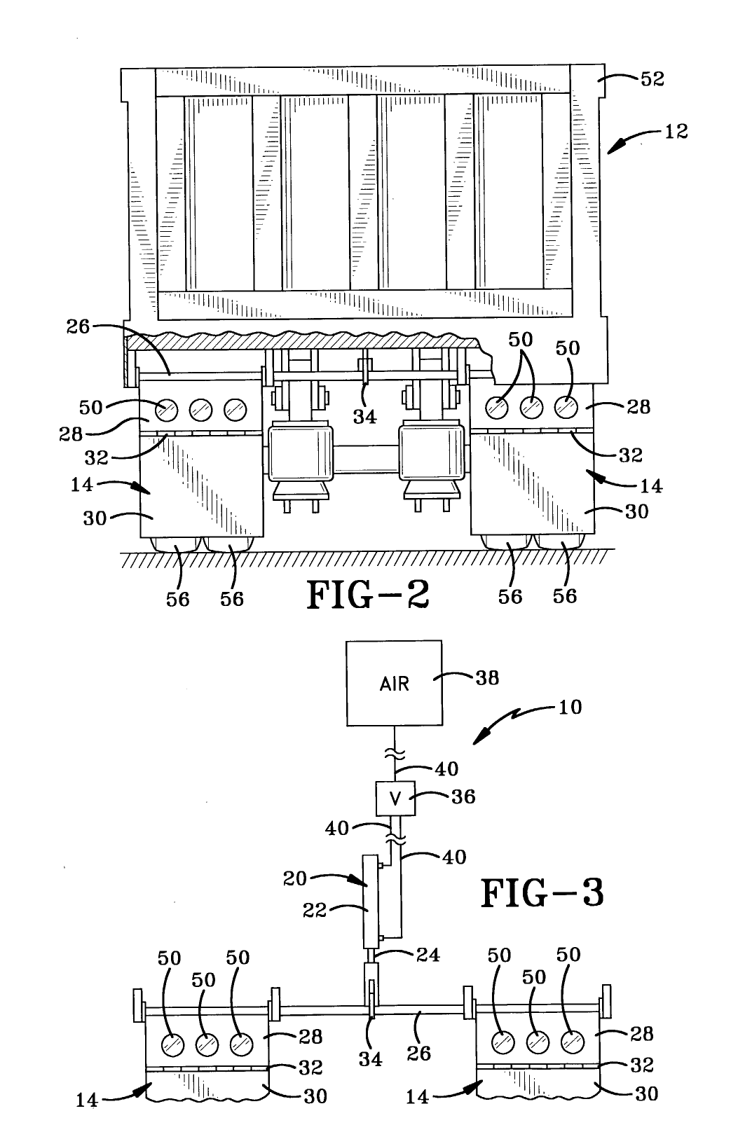

As shown in FIG. 2, upper portion 28 of mud flap assemblies 14 may carry the rear lights 50 of vehicle 12. Lights 50 include driving lights, braking lights, and backing lights.

System 10 may be installed below dump bed 52 and may be disposed intermediate frame members 54. This position protects system 10 and keeps it from projecting outwardly away from the rear end of vehicle 12.

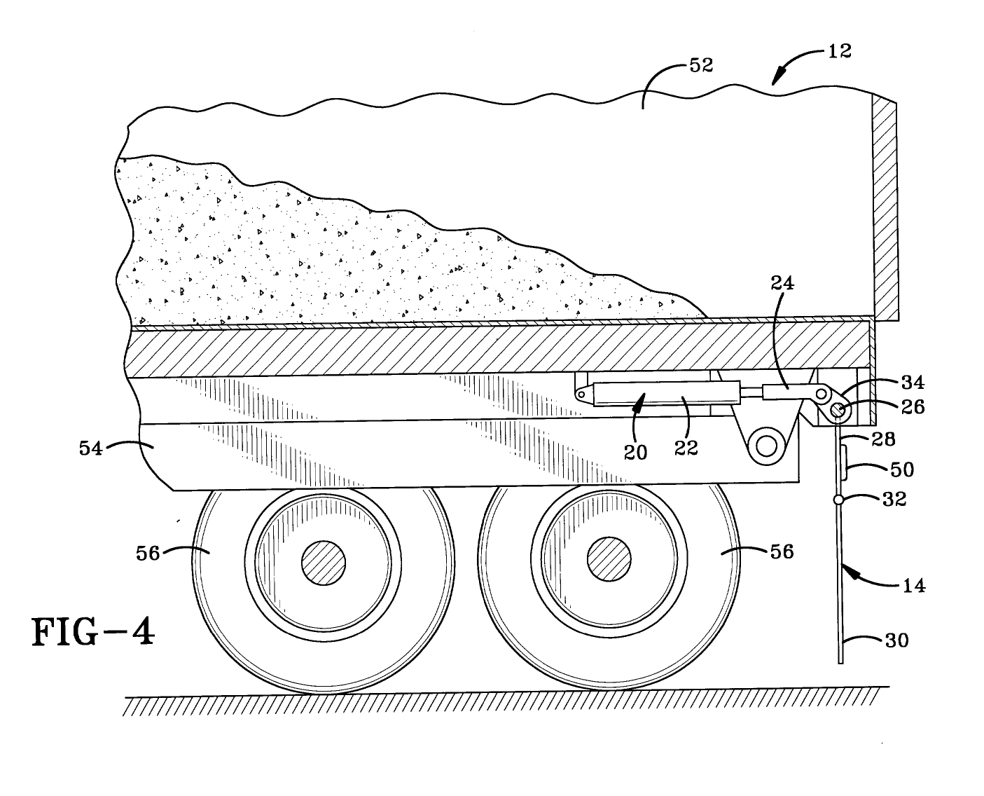

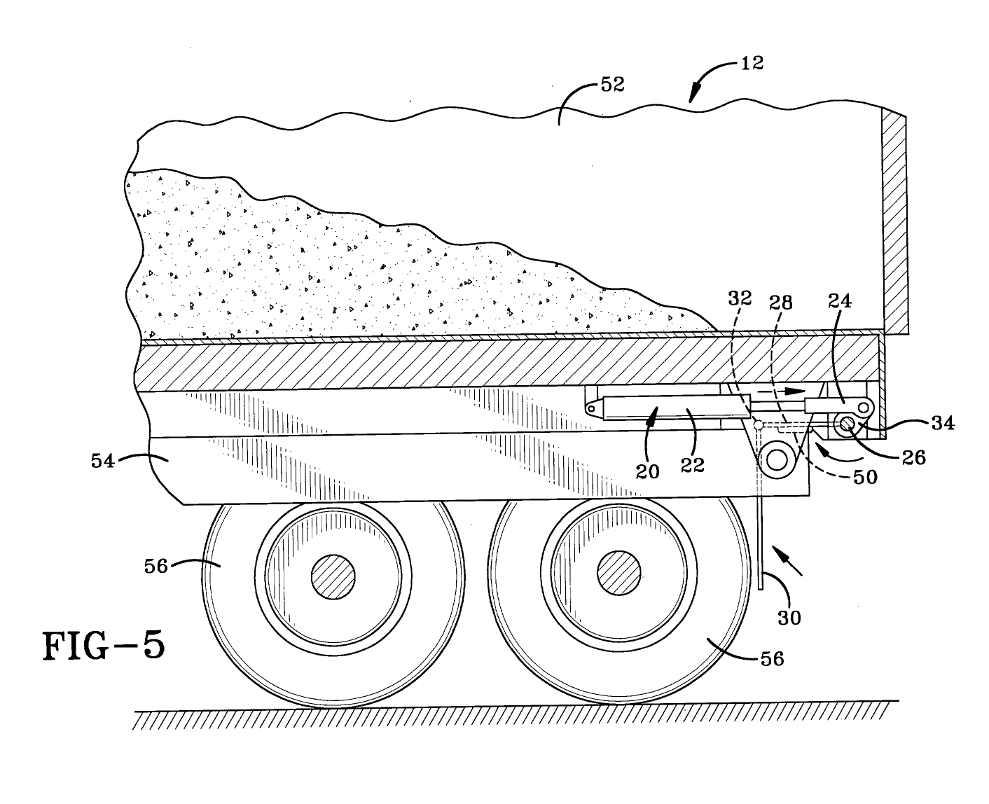

System 10 normally positions mud flap assemblies 14 in the extended position depicted in FIG. 4. In this position, mud flap assemblies 14 meet state requirements for legal street driving and provide adequate protection to vehicles behind vehicle 12 from debris that is thrown from tires 56. When the user wishes to retract assemblies 14, the user actuates valve 36 causing actuator 22 to extend rod 24 rearwardly to a second position. The extension of rod 24 from its first position (FIG. 4) to its second position (FIG. 5) causes lever 34 to pivot about the axial centerline of rod 26. Lever 34 is rigidly connected to rod 26 and thus causes rod 26 to pivot. Upper portions 28 of assemblies 14 are rigidly connected to rod 26 and pivot upwardly to a retracted position as depicted in FIG. 5. Upper portions 28 preferably pivot upwardly and inwardly toward tires 56 90 degrees so that upper portion 28 is substantially horizontal in the retracted position. The movement of upper portion 28 from the extended position to the retracted position causes lower portion 30 to move upwardly and inwardly (or forward) toward tire 56. Lower portion 30 remains substantially vertical during this movement because it pivots about hinge 32 that is disposed at the lower end of upper portion 28. Upper portion 28 is sized to position lower portion 30 closely adjacent (or in contact with) tire 56 when assembly 14 is in the retracted position.

In the retracted position, vehicle 12 may dump its load as depicted in FIG. 6 without the load engaging mud flat assembly 14 thus preventing assembly 14 from becoming damaged.

In alternative embodiments of the invention, actuator 20 may be hydraulic, electric, manually, or mechanically powered. Any of a variety of known actuators may be used in place of the air cylinder described above. In still another embodiment, an actuator may be connected directly to rod 26 to create the rotation.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A mud flap lifting system for a dump truck having a frame and a set of rear wheels; the mud flap lifting system comprising:
an actuator having first and second positions;
a bar pivotally carried by the frame of the truck behind the rear wheels;
at least one mud flap carried by the bar with the mud flap being disposed behind one of the wheels;
the mud flap having an upper portion connected to the bar;
the mud flap having a lower portion pivotally connected to the upper portion of the mud flap; and
the actuator and bar being configured to position the upper and lower portions in an extended position when the actuator is in the first position; the upper and lower portions of the mud flap being substantially vertical when in the extended position; and
the second position of the actuator rotating the bar to pivot the upper portion of the mud flap upwardly and forward toward the tire with the lower portion of the mud flap remaining substantially vertical and closer to the tire than when in the extended position.

2. The system of claim 1, wherein the actuator is a linear actuator.

3. The system of claim 2, wherein the linear actuator is pneumatically actuated.

4. The system of claim 3, wherein the truck includes a supply of pneumatic pressure; the pneumatically-actuated linear actuator being adapted to be powered by the truck's supply of pneumatic pressure.

5. The system of claim 2, further comprising a lever connecting the linear actuator to the bar.

6. The system of claim 1, wherein the upper and lower portions of the mud flaps are connected together with a hinge.

7. The system of claim 6, wherein the hinge is a piano hinge having a length substantially equal to the width of the upper portion of the mud flap.

8. The system of claim 1, further comprising lights carried by the upper portion of the mud flap.

9. The system of claim 1, wherein the actuator is hydraulically actuated.

10. The system of claim 1, wherein the actuator is electrically-powered.

11. The system of claim 1, wherein the upper portion of the mud flap is horizontal when the actuator is in the second position.

12. A mud flap lifting system used with a dump truck having a frame and a pair of rear tires; the frame having a lower surface and the truck having a rear end; the system comprising:
at least one mud flap having a rigid upper portion pivotally connected to a lower portion;
the upper portion of the mud flap being carried by the frame of the truck rearward of the rear tire;
the mud flap having an extended position wherein the upper and lower portions of the mud flap hang substantially vertical; and
actuation means for pivoting the upper portion of the mud flat forward and upwardly with respect to the rear tire to a retracted position wherein the lower portion of the mud flat remains substantially vertical but closer to the rear tire.

13. The system of claim 12, further comprising lights carried by the upper portion of the mud flap.

14. The system of claim 12, wherein the actuation means is carried by the truck between the rear tires.

15. The system of claim 14, wherein the actuation means does not extend beyond the rear end of the truck.

16. The system of claim 14, wherein the actuation means does not extend below the lower surface of the frame.

17. The system of claim 12, wherein the upper portion of the mud flap is substantially horizontal when the mud flap is in the retracted position.

18. A mud flap lifting system for a dump truck having a frame with a pair of frame members and a set of rear tires; the mud flap lifting system comprising:
an actuator having first and second positions;
a bar pivotally carried by the frame of the truck behind the rear wheels;
a pair of mud flaps carried by the bar with one of the mud flaps being disposed behind each of the wheels;
each of the mud flaps having a rigid upper portion connected to the bar;
each of the mud flaps having a lower portion pivotally connected to the rigid upper portion of the mud flap; and
the actuator and bar being configured to position the upper and lower portions in an extended position when the actuator is in the first position; the upper and lower portions of the mud flaps being substantially vertical when in the extended position;
the second position of the actuator rotating the bar to pivot the upper portion of the mud flap upwardly and forward toward the tire with the lower portion of the mud flap remaining substantially vertical and closer to the tire than when in the extended position; and
the upper portion of the mud flap being substantially horizontal when the actuator is in the second position.

19. The system of claim 18, further comprising lights carried by the upper portion of the mud flap.

20. The system of claim 18, wherein the actuator and bar are disposed above the lower surface of the frame members between the rear tires.
